(19) United States
(12) Patent Application Publication
(10) Pub. No.: US 2007/0005932 A1
(43) Pub. Date: Jan. 4, 2007

(54) Memory management in a multiprocessor system

(75) Inventors: Douglas E. Covelli, Santa Clara, CA (US); William K. Cheung, San Jose, CA (US); Koichi Yamada, Los Gatos, CA (US)

Correspondence Address: COURTNEY STANFORD & GREGORY LLP, c/o PORTFOLIOIP, P.O. BOX 52050, MINNEAPOLIS, MN, 55402, US

(73) Assignee: Intel Corporation

(21) Appl. No.: 11/169,412

(22) Filed: Jun. 29, 2005

(51) Int. Cl. G06F 12/00

(52) U.S. Cl. 711/207

(57) ABSTRACT

Embodiments of memory management in a multiprocessor system are disclosed. Embodiments include a system and method for maintaining translation lookaside buffer (TLB) consistency or coherency in a multiprocessor system. A coalescing component receives from a host system a list of TLB pages to be invalidated or purged. The coalescing component uses information of the TLB invalidation broadcast mechanism in use by a processor in the multiprocessor system to evaluate the list of TLB pages. The coalescing component generates a single TLB invalidation message with a variable invalidation range to cover multiple TLB pages of the list or the entire list of TLB pages to be invalidated, and the invalidation message is used to invalidate multiple TLB pages on multiple processors of the host system. Other embodiments are described and claimed.

### FIELD

Embodiments are in the field of memory management in computer systems.

### BACKGROUND

Maintaining coherence or consistency of the translation lookaside buffer (TLB) in multi-processor systems requires some form of inter-processor communication. For example, a change in the TLB mapping of one processor is communicated to all of the processors in the system. In response, each of the processors invalidates indicated TLB pages in order to maintain system memory coherence. Modern processor architectures may provide hardware broadcast mechanisms to speed up this TLB invalidation, or “shootdown”, operation by the operating system. For example, in the Itanium® processor produced by Intel Corporation this broadcast is performed by a purge global translation cache (PTC.G) instruction.

The overhead of such hardware broadcasts has increased significantly due to a number of trends in the computer industry. One trend is the demand for an ever-larger addressing space coupled with the market acceptance of 64-bit processors/operating systems. As most operating systems manage virtual memory in small fixed-size pages (sizes of 4-8 KB are typical), the number of broadcast messages must increase as the virtual memory usage increases, since each broadcast message invalidates a small fixed page size. Another trend is increased numbers of processors in a system, which increases the overhead of broadcast communication proportionally. Recent multi-core and multi-thread processor implementations exacerbate this trend. Yet another trend is a move toward link-based architecture platforms and away from bus based architectures. Link-based architectures do not have true broadcast capability, so an invalidation message must be sent to each processor separately.

Given the above trends to increase the overhead of memory management including the hardware TLB broadcast messages, it is desirable to reduce the communication overhead associated with TLB management. In some cases, the processor architecture already supports a mechanism that could allow invalidation of multiple translations using a single broadcast message with a variable invalidation or purge range. One challenge to implementing a solution that takes advantage of this mechanism has been the difficulty in adopting a processor-implementation specific algorithm in the high level memory manager in portable operating systems.

### BRIEF DESCRIPTION OF THE DRAWINGS

FIG. 1 is a block diagram of a host system that includes a coalescing component for maintaining memory coherence including TLB coherence, under an embodiment.

FIG. 2 is a flow diagram of a coalescing component, under an embodiment.

FIG. 3 is an example showing TLB invalidation using the coalescing component, under an embodiment.

### DETAILED DESCRIPTION

Embodiments of memory management in a multiprocessor system are disclosed herein. Embodiments include a system and method for maintaining memory coherence in a multiprocessor system including translation lookaside buffer (TLB) consistency or coherence. The system and method for maintaining memory coherence in a multiprocessor system are collectively referred to as “TLB invalidation coalescing” or alternatively as “translation cache invalidation coalescing” herein. In one embodiment, a TLB invalidation coalescing algorithm receives from an operating system of the host processing system a list of TLB pages to be invalidated or purged. The TLB invalidation coalescing algorithm uses information of the TLB invalidation broadcast mechanism in use by a processor in the multiprocessor system to evaluate the list of TLB pages and generate a single TLB invalidation message with a variable invalidation range to cover multiple TLB pages of the list or the entire list of TLB pages to be invalidated.

The TLB invalidation coalescing of an embodiment provides broadcasts of TLB invalidation instructions having a variable invalidation size through use of the coalescing component or algorithm in a processor-specific operating system (“OS”) layer. The coalescing component receives a list of pages to be purged from the operating system (e.g., memory manager) and converts the list of pages to be purged to a minimal number of hardware broadcast purge messages. As such, the TLB invalidation coalescing supports an increase in host system scalability because increases in the number of logical processors per core and the number of cores per socket can be realized without proportional increases in TLB purge messages. The TLB invalidation coalescing also may improve performance in multi-processor systems because of the reduced number of TLB invalidation messages required to be broadcasted through the system. As use of TLB invalidation coalescing requires no change in the memory management algorithms in portable operating systems, it increases multi-processor/core/thread scalability from shrink-wrap operating systems.

In the following description, numerous specific details are introduced to provide a thorough understanding of, and enabling description for, embodiments of the memory management system and method. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

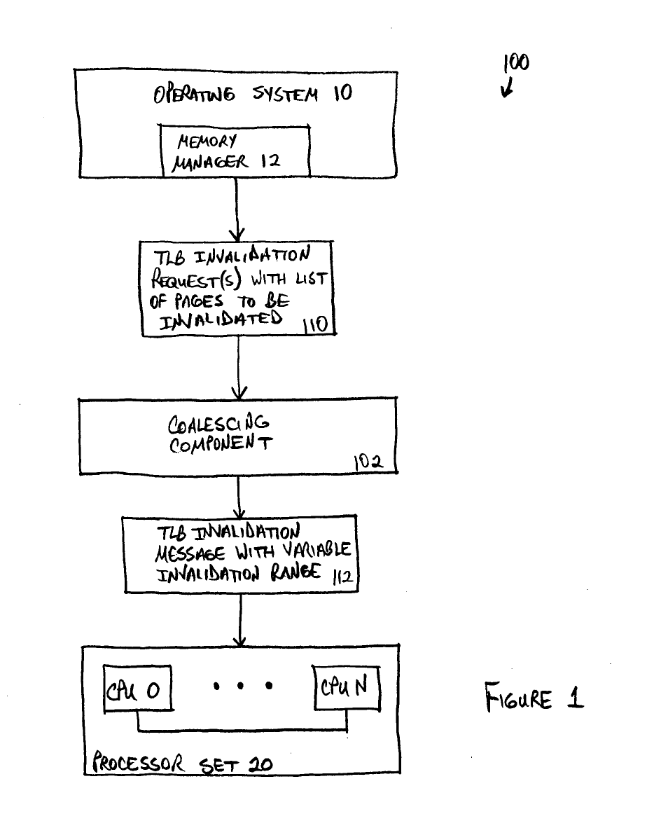

FIG. 1 is a block diagram of a system 100 that includes a coalescing component 102 for maintaining memory coherence including TLB coherence, under an embodiment. The system 100 includes a coalescing component 102 coupled to an operating system 10 and at least one group or set of processors 20. The set of processors 20 may include any number of processors CPU 0, . . . , CPU N coupled in any type and/or combination of configurations as appropriate to the host system 100. The coalescing component 102 may be a processor-specific software layer in the operating system 10 having knowledge of the implementation of the set of processors 20, but is not so limited.

The coalescing component 102 receives from the operating system 10 a TLB invalidation request 110 that includes a list of pages to be invalidated, and generates a single invalidation instruction 112 for use in invalidating multiple pages of the list of pages. The coalescing component 102 provides the invalidation instruction 112 to the set of processors 20 but is not so limited. The coalescing component 102 implements processor-specific algorithms for specific TLB invalidation requests as appropriate to each processor CPU 0, . . . , CPU N of the set of processors 20.

While the term “component” is generally used herein, it is understood that “component” includes circuitry, components, modules, and/or any combination of circuitry, components, and/or modules as the terms are known in the art. While the components may be shown as co-located, the embodiments are not to be so limited; the TLB invalidation coalescing of various alternative embodiments may distribute one or more functions provided by the coalescing component 102 among any number and/or type of components, modules, and/or circuitry of the host system 100.

The operating system 10 includes a memory manager 12, or memory management component 12, and the coalescing component 102 of an embodiment is coupled to the memory manager 12. The memory manager 12 of an embodiment calls the coalescing component 102 to request a TLB invalidation operation, where the request includes a list of pages in memory to be invalidated. The memory manager 12 may be portable across different processor architectures and/or platforms. Use of TLB invalidation coalescing does not require any changes in the operating system and/or memory manager of the host processing system 100. As such, the components or algorithms of the TLB invalidation coalescing can be implemented in low-level layers of the operating system 10 with little or no additional overhead. The processors CPU 0, . . . , CPU N support a mechanism for globally invalidating TLB entries through a broadcast message that has a variable invalidation range. The broadcast message of an embodiment is supported through a processor instruction that specifies a base address and an invalidation size parameter. All page translations in the TLB with virtual addresses and page sizes partially or completely overlapping the specified invalidation address base and invalidation address range are thus invalidated in the TLB in response to the global invalidation instruction. The global invalidation instruction therefore performs TLB invalidation locally as well as globally by broadcasting the invalidation request to all other processors in the coherence domain.

The host system 100 may be a component of and/or hosted on another processor-based system, including a multi-processor system in which the components of the system 100 are distributed in a variety of fixed or configurable architectures. Further, each processor of the processor set 20 may couple to additional resources (not shown). Each processor may be coupled through a wired or wireless network to other processors and/or resources not shown. The additional resources may include memory resources that are shared by the processor and other components of the host system 100. Each processor may also have local, dedicated memory.

The processor set 20 of an embodiment propagates information of the single or global invalidation instruction to globally invalidate TLB entries of each processor using a broadcast message that has a variable invalidation range. The broadcast message with the variable invalidation range may be provided through a purge global translation cache (PTC.G) instruction, for example, but is not so limited. The global translation cache (PTC.G) instruction includes a virtual address and a variable page size. The processor set supports multiple different page sizes in the range of invalidation sizes including but not limited to 4 KB, 8 KB, 16 KB, 64 KB, 256 KB, 1 MB, 4 MB, 16 MB, 64 MB, 256 MB and 4 GB. Additional page sizes supported by the processor set 20 may be obtained through a firmware call or some other means such as a CPUID instruction or register storage for providing implementation specific information.

The actual configuration of the coalescing component 102 is as appropriate to the components, configuration, functionality, and/or form-factor of the host system 100; the couplings shown between the operating system 10, coalescing component 102, and processor set 20 therefore are representative only and are not to limit the system 100 and/or the coalescing component 102 to the configuration shown. The coalescing component 102 can be implemented in any combination of software algorithm(s), firmware, and hardware running on one or more processors, where the software can be stored on any suitable computer-readable medium, such as microcode stored in a semiconductor chip, on a computer-readable disk, or downloaded from a server and stored locally at the host device for example.

The coalescing component 102 may couple among the operating system 10 and the processor set 20 under program or algorithmic control. Alternatively, various other components of the host system 100 may couple to the coalescing component 102. These other components may include various processors, memory devices, buses, controllers, input/output devices, and displays to name a few.

Various alternative embodiments of the host system 100 may include any number and/or type of the components shown coupled in various configurations. Further, while the operating system 10 and coalescing component 102 are shown as separate blocks, some or all of these blocks can be monolithically integrated onto a single chip, distributed among a number of chips or components of a host system, and/or provided by some combination of algorithms. The term “processor” as generally used herein refers to any logic processing unit, such as one or more central processing units (“CPU”), digital signal processors (“DSP”), application-specific integrated circuits (“ASIC”), etc.

The coalescing component 102 generates page invalidation requests in response to memory manager 12 requests to invalidate a list of fixed-size page translations. The coalescing component 102 uses information of the configuration or hardware implementation of the processor set 20 to generate these page invalidation requests. The coalescing component 102 generally maintains TLB consistency by determining a memory page size that includes a range of memory addresses, where the range of memory addresses include multiple TLB pages received in the list of TLB pages. The coalescing component 102 generates a single invalidation message to invalidate entries corresponding to the range of memory addresses at each of multiple processors in a host system.

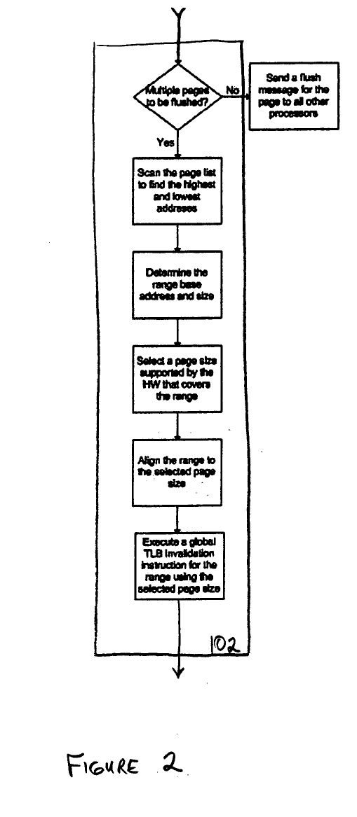

As an example, FIG. 2 is a flow diagram of a coalescing component 102, under an embodiment. The coalescing component sends a flush message for the page to the processor set when a determination 202 is made that only a single page is to be invalidated. When however the coalescing component 102 determines 202 that multiple pages are to be invalidated, the list of pages received in the TLB invalidation request are evaluated and the highest and lowest addresses of these multiple pages are identified 204.

The coalescing component uses information of the highest and lowest addresses of the list of pages to determine 206 a base address and a size of an address range in memory to be invalidated. A page size is selected 208, where the page size is at least as large as the size of the address range to be invalidated so as to include the entire list of pages of the TLB invalidation request. The selected page size may be larger than the size of the address range identified for invalidation but is not so limited. The coalescing component aligns 210 the base address of the address range to the selected page size. The coalescing component generates a single TLB invalidation message that includes information of the aligned base address and the selected page size. The single TLB invalidation message, when received by the processors of the processor set, invalidates all translations in the list of pages for which the memory manager requested invalidation.

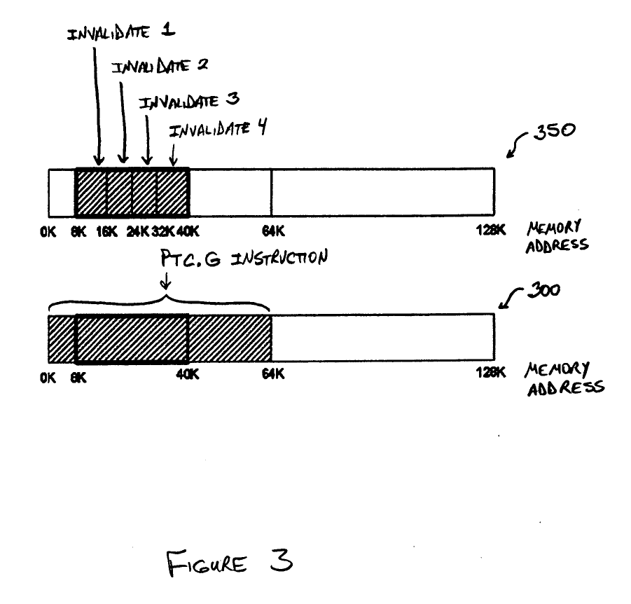

FIG. 3 is an example showing TLB invalidation 300 using the coalescing component, under an embodiment. This example shows TLB invalidation 300 using the coalescing component in comparison to a typical page invalidation scheme 350 under the prior art. In this example, the memory manager or some other component of the host system has provided a list of four (4) pages to be invalidated including pages at addresses 8K, 16K, 24K, and 32K in memory, where each page is 8 KB in size. The typical page invalidation 350 without the coalescing component would invalidate each page individually using four (4) invalidation instructions (e.g., Invalidate 1, Invalidate 2, Invalidate 3, Invalidate 4), and each of the four invalidation instructions would invalidate a single page of size 8 KB. Consequently, the four invalidation instructions would result in generation and transmission of four (4) broadcast messages across the host system.

In contrast, the TLB invalidation 300 using the coalescing component scans the received list of pages to be invalidated and determines an optimal invalidation size that spans the entire list of pages to be invalidated. This example is invalidating four (4) 8 KB pages (32 KB total), so the optimal invalidation size that covers this address range is selected as 64 KB considering the embodiment described above that supports page sizes including but not limited to 4 KB, 8 KB, 16 KB, 64 KB, 256 KB, 1 MB, 4 MB, 16 MB, 64 MB, 256 MB and 4 GB. The coalescing component thus invalidates the four pages by issuing a single global translation cache (PTC.G) instruction, for example, with a base address of 0 and a size of 64K. The base address is chosen to be zero (0) to align the address range on a 64K boundary when a page size of 64K is used, but the embodiment is not so limited.

This example shows that as a result of the number of pages to be invalidated and the size of each page there may be some over-purging in that the closest supported page size (64 KB in the example above) is larger than the total address range to be invalidated (32 KB in the example above). However, allowing for a small amount of over-purging may yield better performance because of the reduced number of broadcast messages resulting from the coalescing of an embodiment. The coalescing component of an embodiment manages or controls the amount of over-purging to be relatively small since the operating system (e.g., memory manager) generally tends to provide a contiguous list of pages for purging.

The effects of over-purging may also be insignificant because the probability of invalidating a TLB entry that was currently in use on the target processor is generally low due to the typically small size of the TLBs and the memory reference characteristics of typical workloads. Further, the cost of over-purging an entry is low because the TLBs may be backed by the hardware page table walker which can fill the TLBs without causing an exception.

The coalescing component of an alternative embodiment may use a small number of TLB invalidation instructions rather than a single broadcast message to minimize the amount of over-purging. For example, assume the memory manager has provided a list of three (3) pages to be invalidated, including pages at memory addresses 0K, 8K, and 24K, where each page is 8 KB in size. In order to reduce over-purging, the coalescing component selects an optimal invalidation size that spans the first two pages to be invalidated. Therefore, the optimal invalidation size that covers this address range is 16 KB considering the embodiment described above that supports page sizes including but not limited to 4 KB, 8 KB, 16 KB, 64 KB, 256 KB, 1 MB, 4 MB, 16 MB, 64 MB, 256 MB and 4 GB. The coalescing component thus issues a first TLB invalidation instruction with a base address of 0 and a size of 16K to invalidate the first two pages and a second TLB invalidation instruction with a base address of 24K and a size of 8K to invalidate the third page.

The coalescing component of an embodiment, in generating global TLB invalidation instructions, considers one or more of broadcast message latency, the number of processors in the processor set or system and the processing overhead. The coalescing component uses information of these parameters in determining when to coalesce multiple invalidation instructions, how many pages to coalesce in a single invalidation instruction, the invalidation page size to be used for the instruction, and an allowable amount of over-purging, to name a few. Other parameters of the host system may also be used in generating an invalidation instruction.

The use of TLB invalidation coalescing over the conventional non-coalescing approach reduces traffic on the interconnect structure of the host system. In a bus-based system that includes 64 processors with a shared bus, for example, and assuming invalidation of 100 contiguous pages (“M”), the use of coalescing to generate global TLB invalidation instructions results in a reduction of 99 broadcast messages in a bus-based system, as follows:
Number of messages sent without coalescing M=100;
Number of messages sent with coalescing=1;
Number of messages saved=100−1=99 messages.

In a point-to-point system that includes 64 processors, for example, and assuming invalidation of 100 contiguous pages (“M”), the use of TLB invalidation coalescing as described herein to generate global TLB invalidation instructions results in a reduction of 6,237 broadcast messages, as follows:
Number of messages sent without coalescing=M*(N−1)=100*63=6300;
Number of messages sent with coalescing=1*(N−1)=1*63=63;
Number of messages saved=6300−63=6327 messages;
where “M” is a number of pages to be invalidated, and “N” is a number of processors.

The actual number of clock cycles saved on the processor sending the invalidation instructions depends on the configuration of the host system; however the number of saved clock cycles will increase as the number of processors increases. For example the latency of a PTC.G instruction as seen by a sending processor in a system having 32 cores is estimated to be 2000 clock cycles. If the number of cores is increased to 64 the estimated latency increases to 2400 clock cycles. The number of clock cycles saved on the 64-core system can be calculated for example to be approximately 15.2 M clock cycles as:
L(N)=instruction latency in N-processor system=L(64)=2400;
S=Number of messages saved=6,327;
Latency reduction on sending processor=S*L(N);
Latency reduction on sending processor=6327*2400;
Latency reduction on sending processor=15.2 M clocks.

Additionally, each target processor receiving an invalidation instruction must process the instruction. If the message processing is emulated in firmware for example, this processing may require operations like flushing the pipeline, re-steering to the appropriate handler, fetching the emulation code from memory, saving state, executing the emulation code, restoring state, and resuming the interrupted code. The instruction processing can therefore take on the order of hundreds of CPU cycles. Since each target processor must perform the instruction processing, the system-wide performance loss grows with the number of processors and is proportional to (N−1)*M. For large values of N and/or M the bus bandwidth and CPU cycles devoted to maintaining TLB coherence can lead to significant performance degradation in the absence of TLB invalidation coalescing.

The effect of TLB invalidation coalescing over the conventional non-coalescing approach can also provide significant savings in CPU cycles at the target processors. Considering again an example system having 64 processors invalidating 100 pages, and assuming the firmware emulation takes 100 CPU cycles, invalidation coalescing saves approximately 624K CPU cycles system wide for an approximate reduction in CPU cycles of 99%. The calculations are as follows:
M=100;
N=64;
T=time for target processor to perform a firmware emulation=100 clocks;
Overhead without coalescing=M*(N−1)*T=100*63*100=630K clocks;
Overhead with coalescing=1*(N−1)*T=1*63*100=6,300 clocks;
Clocks saved on receiving processors=630K−6,300=623.7K clocks.

By measurement, the majority of TLB invalidation requests from some operating systems (e.g., memory manager) have been found to be contiguous. Data collected showed that application of the TLB invalidation coalescing to the MSC.Nastran™ benchmark for example reduced the number of TLB invalidate messages by approximately 97% (e.g., reduced the number of TLB invalidate messages from 35K messages per second to 470 messages per second) (the MSC.Nastran™ benchmark is a widely used computer-aided engineering program for linear and non-linear analyses of structural, fluid, thermal, and coupled systems).

Aspects of the TLB invalidation coalescing described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the TLB invalidation coalescing include: microcontrollers with memory (such as EEPROM), embedded microprocessors, firmware, software, etc. Furthermore, aspects of the TLB invalidation coalescing may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, etc.

It should be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of TLB invalidation coalescing is not intended to be exhaustive or to limit the TLB invalidation coalescing to the precise form disclosed. While specific embodiments of, and examples for, the TLB invalidation coalescing are described herein for illustrative purposes, various equivalent modifications are possible within the scope of the TLB invalidation coalescing, as those skilled in the relevant art will recognize. The teachings of the TLB invalidation coalescing provided herein can be applied to other systems and methods, not only for the systems and methods described above.

The elements and acts of the various embodiments described above can be combined to provide further embodiments. These and other changes can be made to the TLB invalidation coalescing in light of the above detailed description.

In general, in the following claims, the terms used should not be construed to limit the TLB invalidation coalescing to the specific embodiments disclosed in the specification and the claims, but should be construed to include all systems that operate under the claims. Accordingly, the TLB invalidation coalescing is not limited by the disclosure, but instead the scope of the TLB invalidation coalescing is to be determined entirely by the claims.

While certain aspects of the TLB invalidation coalescing are presented below in certain claim forms, the inventors contemplate the various aspects of the TLB invalidation coalescing in any number of claim forms. For example, while only one aspect of the TLB invalidation coalescing is recited as embodied in machine-readable medium, other aspects may likewise be embodied in machine-readable medium. Accordingly, the inventors reserve the right to add additional claims after filing the application to pursue such additional claim forms for other aspects of the TLB invalidation coalescing.

What is claimed is:

1. A method for maintaining translation lookaside buffer (TLB) consistency, comprising:
determining a memory page size that includes a range of memory addresses, the range of memory addresses including a plurality of TLB pages received in a list of TLB pages; and
generating an invalidation message to invalidate entries corresponding to the range of memory addresses at each of a plurality of processors.

2. The method of claim 1, wherein determining a memory page size includes identifying at least one highest memory address and at least one lowest memory address of the plurality of TLB pages.

3. The method of claim 1, wherein determining a memory page size includes determining a size of an address range that includes the plurality of TLB pages.

4. The method of claim 1, further comprising:
determining a base address of the range of memory addresses; and
aligning the base address to the memory page size, the memory page size including the base address.

5. The method of claim 1, further comprising broadcasting the invalidation message to the plurality of processors.

6. The method of claim 1, further comprising invalidating entries of the plurality of TLB pages at each of the plurality of processors using information of the invalidation message.

7. The method of claim 1, wherein determining a memory page size comprises selecting a page size from a plurality of pre-specified memory page sizes.

8. The method of claim 1, wherein the plurality of TLB pages includes all TLB pages of the list of TLB pages.

9. The method of claim 1, wherein the plurality of TLB pages includes a subset of TLB pages of the list of TLB pages.

10. A machine-readable medium including instructions which when executed in a processing system maintain translation lookaside buffer (TLB) coherency by:
identifying at least one of a highest and lowest memory address of a plurality of TLB pages received in a list of TLB pages;
determining a size of an address range that includes the highest and lowest memory address;
selecting a memory page size that includes the address range; and
generating a global invalidation instruction that invalidates memory addresses of the selected memory page size.

11. The medium of claim 10, further comprising determining a base address of the address range, wherein the selected memory page size includes the base address.

12. The medium of claim 10, further comprising aligning a base address of the address range to the selected memory page size.

13. The medium of claim 10, further comprising transferring the global invalidation instruction to at least one processor of a plurality of processors.

14. The medium of claim 10, further comprising invalidating entries of a plurality of memory addresses corresponding to the memory page size at each of a plurality of processors using information of the global invalidation instruction.

15. A processing system comprising:
an operating system;
a plurality of processors; and
a coalescing component coupled to the operating system and the plurality of processors, the coalescing component maintaining coherency of translation lookaside buffers (TLBs) among the plurality of processors by:
receiving a list of TLB pages from the operating system;
determining a memory page size that includes a range of memory addresses of a plurality of TLB pages of the list; and
generating an invalidation message to invalidate entries corresponding to the range of memory addresses at each of a plurality of processors.

16. The system of claim 15, wherein the coalescing component determines the memory page size by determining a size of an address range that includes the plurality of TLB pages, wherein determining a size of an address range includes identifying at least one highest memory address and at least one lowest memory address of the plurality of TLB pages.

17. The system of claim 15, wherein the coalescing component determines a base address of the range of memory addresses and aligns the base address to the memory page size.

18. The system of claim 15, wherein one of the plurality of processors receives the invalidation message and broadcasts the invalidation message to other processors of the plurality of processors.

19. The system of claim 15, wherein each of the plurality of processors invalidates entries of the plurality of TLB pages using information of the invalidation message.

20. The system of claim 15, wherein determining a memory page size comprises selecting a page size from a plurality of pre-specified memory page sizes.

21. The system of claim 15, wherein the plurality of TLB pages includes all TLB pages of the list of TLB pages.

22. The system of claim 15, wherein the plurality of TLB pages includes a subset of TLB pages of the list of TLB pages.
